(19) United States
(12) Patent Application Publication
(10) Pub. No.: US 2005/0219362 A1
(43) Pub. Date: Oct. 6, 2005

(54) Quality analysis in imaging

(75) Inventor: Maurice V. Garoutte, Dittmer, MO (US)

Correspondence Address: GREENSFELDER HEMKER & GALE PC, SUITE 2000, 10 SOUTH BROADWAY, ST LOUIS, MO, 63102, US

(73) Assignee: Cernium, Inc.

(21) Appl. No.: 11/093,772

(22) Filed: Mar. 30, 2005

Related U.S. Application Data
(60) Provisional application No. 60/557,778, filed on Mar. 30, 2004.

(51) Int. Cl. H04N 17/02

(52) U.S. Cl. 348/180

(57) ABSTRACT

Software-implemented system and methodology to objectively quantify criteria that can produce a score indicating the quality of a video or comparable image-producing signal or other image file or sequence of display frames containing electronically reproduced or generated images. Where video is to be analyzed, executing the criteria produces a score indicating the quality of a video signal in a sequence of video frames. Three principle criteria are analyzed and then combined to produce an objective score representing video or image quality, viz., a grayscale histogram, and edge histogram, and a horizontal versus vertical sharpness graph. As each frame, as in a sequence of image frames of a video signal, is made available for analysis or to be shown within a display area, the frame is analyzed by digital processor to produce the grayscale histogram, the edge histogram, and the horizontal versus vertical sharpness graph. The results of these criteria are combined to produce a video quality score indicative of the quality of the frame of video.

### CROSS-REFERENCE TO RELATED APPLICATION

This application claims the priority of U.S. provisional patent application Ser. No. 60/557,778, filed Mar. 30, 2004, entitled QUALITY ANALYSIS IN IMAGING.

### BACKGROUND OF THE INVENTION

1. Field of the Invention

The invention relates to image analysis and display, and to video and other images reproduced or displayed for various purposes, and more particularly, to software-implemented methods and system for determining the quality of electronically reproduced or generated images and to improvements in determining objectively the quality of a video signal for purposes such as reproduction, recording, analysis, display, processing and other uses.

2. Description of the Known Art

Determining objectively the quality of images, such as those provided by video capture, has historically been difficult. The quality of a video signal, for example, is typically very subjectively determined, being often solely dependent upon viewer perception.

There has been developed a system of the present inventor in accordance with U.S. patent application Ser. No. 09/773,475, filed Feb. 1, 2001, entitled SYSTEM FOR AUTOMATED SCREENING OF SECURITY CAMERAS, and corresponding International Patent Application PCT/US01/03639, of the same title, filed Feb. 5, 2001, both assigned to the same entity as the owner of the present application, and both herein incorporated by reference. That system, also called a video analysis or video security system, may be identified by the trademark PERCEPTRAK (“Perceptrak” herein). In the Perceptrak system, video data is picked up by any of many possible video cameras. It is processed by software control of the system before human intervention for an interpretation of types of images and activities of persons and objects in the images. As the video may be taken by video cameras in any of many possible locations and under conditions subject to variation beyond the control the system, the captured video can include useless information considered to be noise because it interferes with usable information or detracts from or degrades video data useful to the system.

More specifically, the Perceptrak system provides automatically screening of closed circuit television (CCTV) cameras (“video cameras”) for large and small scale security systems, as used for example in parking garages. The Perceptrak system includes six primary software elements, each of which performs a unique function within the operation of the system to provide intelligent camera selection for operators, resulting in a marked decrease of operator fatigue in a CCTV system. Real-time image analysis of video data is performed wherein a single pass of a video frame produces a terrain map which contains parameters indicating the content of the video. Based on the parameters of the terrain map, the system is able to make decisions about which camera an operator should view based on the presence and activity of vehicles and pedestrians, furthermore, discriminating vehicle traffic from pedestrian traffic. The system is compatible with existing CCTV (closed circuit television) systems and is comprised of modular elements to facilitate integration and upgrades.

The determination of video quality is useful and important in the operation of the Perceptrak system and in many other systems for analysis of video and other images.

### BACKGROUND OF THE INVENTION

A quantitative set of distinct criteria can be considered usefully and descriptively characteristic of electronically reproduced or generated images such as video frames, for example, so that the criteria can be measured, analyzed and then combined to produce an objective quality score representing the quality of the signal. Such a quality score is thought to be useful in a side variety of uses and technologies dealing with video and related displays, whether created by analog or digital techniques, and to digital photography and video image capture and reproduction or use.

By way of example, the quality score once calculated can provide an objective value that correlates directly with a frame of a video stream, for example, or a series or sequence of frames, and then can be used to verify the quality of that frame. It is further considered that the score will be of such value that a high score will give the viewer or user assurance that the video signal is of a high quality. So also, the quality score should also be useful for being recognized and used in video processing, display, manipulation and other video-employing technologies and devices where dependence and reliance upon the quality score reliably can be taken into account during processing and handling of video so scored, as by machine-implemented technique or software.

The general term “software” is herein simply intended for convenience to mean programs, programming, program instructions, code or pseudo code, process or instruction sets, source code and/or object code processing hardware, firmware, drivers and/or utilities, and/or other digital processing devices and means, as well as software per se.

In the present disclosure of methods and systems for determining the quality of video and other electronically reproduced or generated images, involving improvements in determining objectively the quality of a video signal for reproduction or display or processing, the trademark “Check Video” serves to identify the new methods and system.

Accordingly, among the objects, features and advantages of the invention may be noted the provision of methodology and system which can provide a quality score for evaluation of images electronically reproduced or generated images, such as video; which can provide such a quality score which can be correlated with frames of a video stream; which can provide a quality score based upon a quantitative set of distinct criteria associated with such images; which can provide a quality score usefully and descriptively characteristic of image frames, especially video; which can provide a quality score objectively represents the quality of a video signal and/or other electronically reproduced or generated images associated, e.g., as provided by video; and which can provide a quality score useful in a side variety of uses and technologies dealing with video and related displays, whether created by analog or digital techniques.

Briefly, the presently inventive is a software-implemented system solution to such problems, being a system and method capable of providing the ability to objectively quantify image criteria that can produce a score indicating the quality of a video signal or other electronically-generated images. Three main criteria are analyzed and are then combined to produce an objective score representing the quality of a video signal.

More specifically, in a system, such as the above-identified Perceptrak system, for capturing video of scenes, including a processor-controlled selection and control system for providing software-implemented segmentation of subjects of interest in said scenes based on processor-implemented interpretation of the content of the captured video, the present invention is an improvement comprising software implemented objective quantification of criteria associated with the video to produce a composite, or total, quality score indicating the quality of said video or other image data, including single or multiple image frames, or sequences of frames. Three main criteria are analyzed under processor control to produce respective criteria results. The criteria may be displayed and scored electronically for viewing, and/or may be written electronically to an array with or without viewing. The scoring results are then combined to produce an total score representing the quality of the video. Real-time scoring is achieved. The total score can be displayed or provided by possible indicators, whether visual or oral or otherwise, for real-time indication, or can be used in a system or for further processing, such as for equipment checking, archiving, or for either present or later-time assessment.

The three criteria are a grayscale histogram, and edge histogram, and a horizontal versus vertical sharpness graph. As each frame of a video signal of a stream of successive video frames is shown within the display area, that frame is also analyzed to produce the grayscale histogram, the edge histogram, and the horizontal versus vertical sharpness graph. As applied to a frame of video, the results of the three criteria when combined as a video quality score are such that the score is objectively indicative of the quality of that frame of video. Successive frames readily may be so analyzed in quality on a real-time basis.

An example of the methodology by visual display is provided. An example also is provided of signalling quality of video frames by audible tones.

The invention achieves various objects and advantages. For example, when viewing video frames over time corresponding histogram graphs provide a capability to discern the overall quality of the video signal. The video quality score which is obtained may be archived with the video, as the video is itself archived. The score may determine in what ways the video will be processed, further analyzed or otherwise used. The total score becomes a artifactual record permanently useful as indicative of the quality level of video it accompanies. Archived scores correlated to archived video may also serve to determine a priori whether archived video images will, upon retrieval, be useful.

The inventive technology is useful in many ways and in many technologies, including video analysis systems, video security systems, video capture systems, and various video image analysis and recognition technologies, “photo studio” video imaging, broadcasting, digital video display and processing, and for video recordation for whatever purposes.

Other objects, features and advantages will be apparent from the following description and claims.

### BRIEF DESCRIPTION OF THE DRAWINGS

FIG. 1 shows a grayscale histogram for a horizontal gradient to be considered, as within a frame of a video stream plotting pixels vs. intensity levels, being one of the histograms used in accordance with the invention.

FIG. 2 shows a grayscale histogram for a flat intensity video image of a mid-tone gray.

FIG. 3 shows another gradient pattern across an image, full range of intensity values being present.

FIG. 4 shows a typical video scene from a parking garage, with the image histogram.

FIG. 5 shows an image of a gradient that moves from black to white and its associated edge histogram.

FIG. 6 shows a mid-tone gray image with its edge histogram.

FIG. 7 shows an image comprised of a random noise distribution of intensity values with an edge histogram thereof.

FIG. 8 shows a typical video scene from a parking garage with its corresponding edge histogram.

FIG. 9 shows a flat mid-tone gray image and its corresponding horizontal versus vertical sharpness graph.

FIG. 10 shows an image containing a block letter E with a horizontal versus vertical sharpness graph.

FIG. 11 shows the same block letter E as in FIG. 10 but showing effects of high frequency roll-off, with an together, associated horizontal versus vertical sharpness graph.

FIG. 12 shows a video image at an outdoor parking facility with its associated horizontal versus vertical sharpness graph.

FIG. 13 shows a zoomed-in version of one of the vehicles from the parking facility in FIG. 12.

FIG. 14 is computer monitor screen display for illustrating graphic depiction of applied criteria of the present methodology, together with a reproduced portion of a video-captured scene, and total score display for the scene based on use of the criteria, and displaying also histogram and graphic depiction of the applied criteria, and thus indicating a first exemplary method of presenting the total score.

FIG. 15 is a block diagram illustrating an exemplary method of another use of a total score created by the present methodology.

### DESCRIPTION OF PRACTICAL EMBODIMENTS

Referring to the drawings, the features provided by the new methodology and system are illustrated, and representative pseudo code is set forth.

The proposed software-implemented system provides the ability to objectively quantify criteria that can produce a quality score indicating the quality of a video signal. Three main analytical criteria are calculated by signal analysis and the results thereof are then combined by suitable processor (not shown), such as microprocessor module of commercially available type, namely a computer or signal processing device wherein method steps for carrying out the present methodology are encoded in a software program adapted for execution on any one of a variety of known type signal processing devices in any one of a number of different operating system protocols. The processor may be that or like that disclosed in the above-identified Perceptrak system. The processor is to produce an objective score, which may most preferably be numerical, representing the quality of a video signal. The score is hereinbelow referred to as a total score.

The three criteria, or tests, which may accordingly be software-implemented by such a microprocessor system, are most preferably (1) a grayscale histogram, (2) an edge histogram, and (3) a horizontal versus vertical sharpness graph. Herein they may be referred to for convenience as Criterion 1, Criterion 2 and Criterion 3. As each frame of a video signal is shown within the display area of a system using check video, that frame is also analyzed to produce the grayscale histogram, the edge histogram, and the horizontal versus vertical sharpness graph. The two histograms and sharpness graph data, thus representing the respective data results or outputs of Criteria 1 to 3, may be written to conventional semiconductor dynamic arrays (not shown). The results of the three criteria then are combined to produce a video quality score objectively indicative of the quality of that frame of video.

More specifically, analytic use is made of these histograms and graphic analysis, as follows.

Grayscale Histogram. A histogram is defined as a graphical representation of the frequency distribution of observed values within a continuous range. Such a histogram may be displayed, or it may exist in dynamic semiconductor memory, for example. In a graphic representation, rectangles are drawn such that their bases lie on a linear scale representing different intervals. The heights of the rectangles are proportional to the frequency of the values within a given interval.

Using this as a basic definition of a histogram, a grayscale histogram shows or represents the frequency distribution of intensity values within an image. The representation may be visually presented or realized in a an array by means of digital processor. In an image with a bit depth of 8, as most often used for grayscale images, there are 256 discrete intensity levels.

The X-axis represents these intensity values in a range from 0 to 255. The range of values for a grayscale histogram start at the far left with the color black represented by a value of 0 and end at the far right with the color white represented by a value of 255. A value of 127 represents a mid-gray color.

The Y-axis indicates the frequency of occurrences within each intensity. In the case of a grayscale histogram, that frequency is the number of individual pixels within the image of the particular intensity value. If no rectangle is present for a particular channel or the Y value is 0 then there are no pixels of that intensity within the image.

The following figures and examples show the correlation between an image and its grayscale histogram.

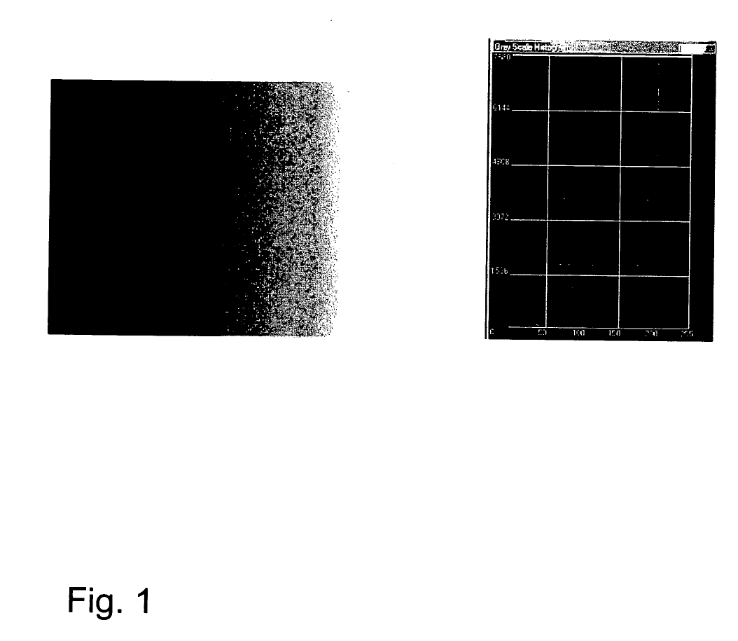

FIG. 1 shows a grayscale histogram for a horizontal gradient. The gradient in this image follows the direction of the histogram in that it moves from black at the far left to white at the far right. The grayscale histogram shows or represents, as one would expect, a very even distribution of intensity values across the image. All intensity values are present within the image leaving no gaps in the grayscale histogram.

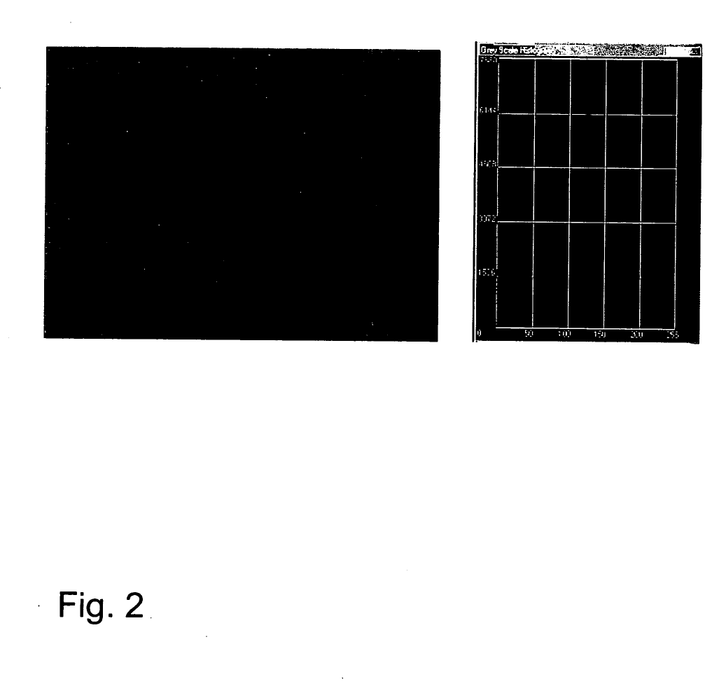

FIG. 2 shows a grayscale with its associated histogram for a flat intensity image of a mid-tone gray. The intensity value of this gray is valued at 127, in a possible value range of 0 through 255. The grayscale histogram shows or is a representation that all of the pixels where found to be of intensity value 127. No other bars exist within this grayscale histogram, showing that all of the data within this image is of intensity value 127.

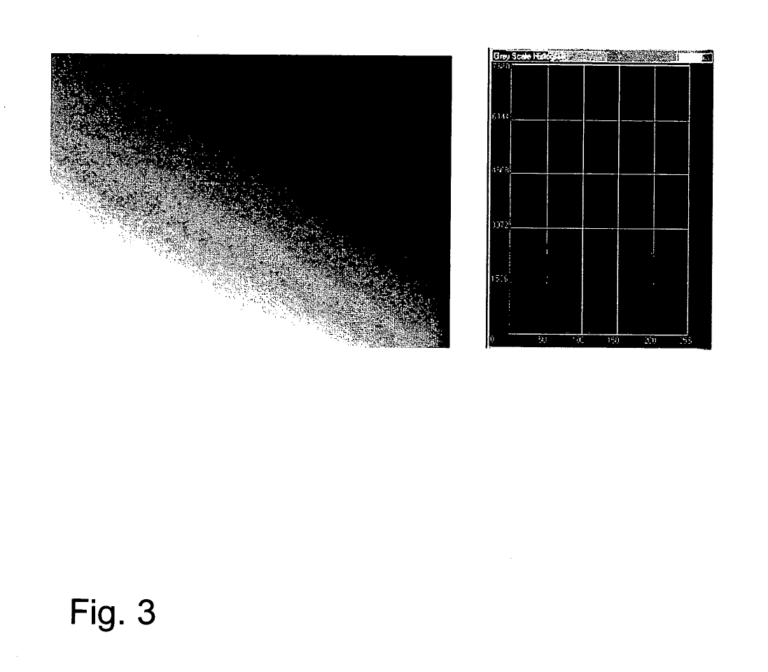

FIG. 3 shows another gradient pattern across an image, and its related grayscale histogram which shows again that a full range of intensity values is present. However, the distribution of these values is different from the gradient picture of FIG. 2. The grayscale histogram of FIG. 3 shows that there are a greater number of pixels within the mid-range grays of the image than in either the blacks or whites. This is visually confirmed in the opposing corners of the image where only a little white or black resides.

Contrast of an image is very important to the amount of detail that can be seen in a given image. An even distribution across the grayscale histogram will produce the best contrast and thus provide the most detailed image. A distribution of intensity levels in the low range indicates an image that is too dark and contains a lot of noise. A distribution of intensity levels in the high range indicates an image that is over saturated and has little definition of objects.

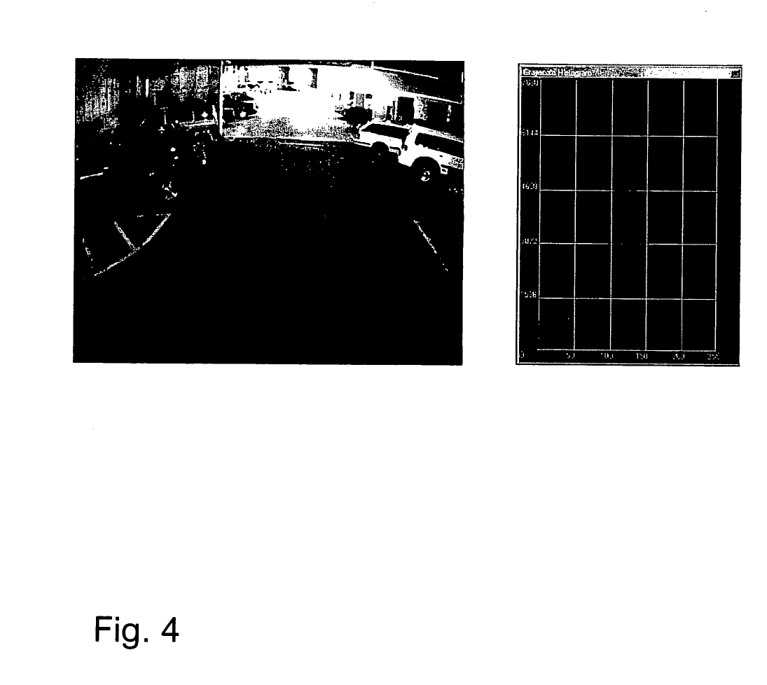

FIG. 4 shows a typical scene from a parking garage, with its associated image histogram. This is a good contrast image with all of the objects within the image sharp, well-defined, and easily recognizable. Looking at the corresponding grayscale histogram, one sees an even distribution of intensity values across the image with the majority of the intensities falling in the mid-tone gray ranges. A spike in the values in the white range of the grayscale histogram shows that there is also a significant amount of whites in the image though many of the black ranges have dropped out.

Utilizing the grayscale histogram on a video stream provides a quick reference to the quality of an image. A grayscale histogram that shows an even distribution of intensity values tells the user that the image is a good one because it displays the entire spectrum of data evenly. The present quality analysis methodology and system allows a user to make use of the grayscale histogram as it changes upon receiving a video signal. By making adjustments to the brightness and contrast of the video signal, one can have a visual reference with which to determine a better quality of video signal.

It is important to note that such a grayscale histogram, while representing the distribution of image intensities, does not retain any spatial information. Given the above image flipped in reverse order so that a different image, one moving in a gradient from white to black, would produce the exact same grayscale histogram. The numbers of pixels of a given intensity within the image have not changed; rather only their placement within the image is changed. Thus it is possible to have many images that produce identical or exceedingly similar grayscale histograms.

Edge Histogram: An edge histogram shows or represents the frequency distribution of edges found within a given image. The edge histogram representation may be visually presented or realized in a an array by means of digital processor. An edge consists of an increase or decrease in the intensity information of a group of pixels. The greater the difference within group, the higher the edge. For example, a black pixel of intensity value 0 next to a white pixel of intensity value 255 would produce a very high edge across the value with the difference of the two pixels equaling a magnitude 255. However, two pixels of the same value, such as two pixels both equaling a mid-tone gray of intensity value 127, will have no edge since there is no distinguishable difference between the two intensities. The difference between these two gray pixels will yield a magnitude of 0 indicating no edge is present.

The X-axis of such an edge histogram represents the magnitude of the edge in a range from 0 to 255. The range of values in the edge histogram starts on the left with 0 and move to the right ending at 255. A value of zero represents no edge present and a value of 255 represents the greatest difference between two intensity values creating the most prominent edge. The magnitude of the edge is based upon the degree of slope as determined during the creation of a terrain map in accordance with the above-described disclosure of the Perceptrak system.

The Y-axis indicates the frequency of the occurring degrees of slope. In the case of an edge histogram the frequency is the number of degrees of slope for that particular magnitude. If no rectangle is present for a particular channel or the Y value is 0 then there are no edges of that magnitude within the image.

The following figures and examples will show the correlation between an image and its associated edge histogram.

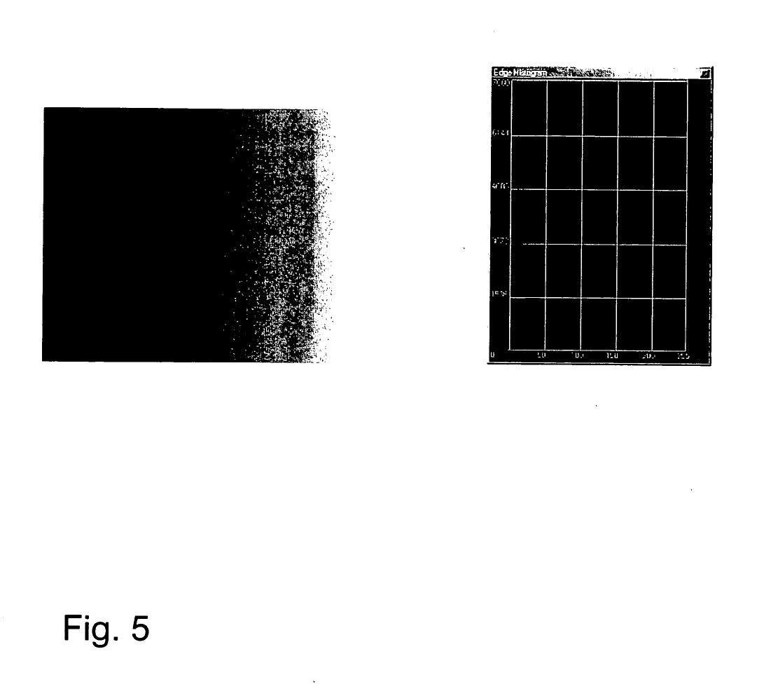

FIG. 5 shows an image of a gradient that moves from black to white and its associated edge histogram. In this edge histogram it is noticeable that most of the values lie in the lower ranges of the histogram. This demonstrates that while there are many edges within this image due to the gradation of intensity values, the degree of slope between any groupings of edges is very small. With such an edge histogram as this, one can know that there are very few definable hard edges within the image. Without hard edges no shapes can be readily identifiable.

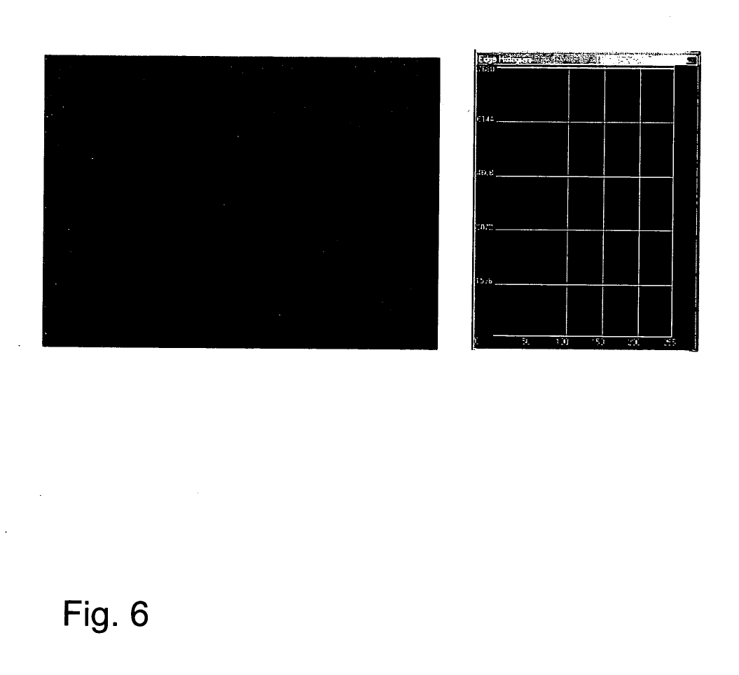

FIG. 6 shows a mid-tone gray image. The accompanying edge histogram for this image is simple and straightforward. With an image of all the same intensity values, no edges can occur. Therefore, all values within this image will produce a degree of slope of zero value. This is reflected in the edge histogram where the only values visible are in the zero range.

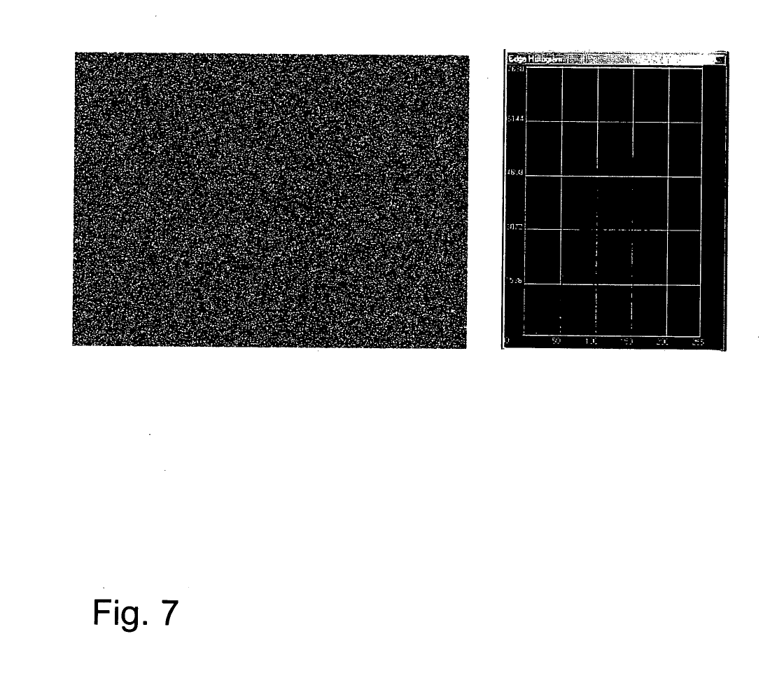

FIG. 7 shows an image comprised of a random noise distribution of intensity values. The corresponding edge histogram of the figure shows that most of the values of the degree of slope reside in the midranges of the histogram. This tells us that while there are no cases where the degree of slope is zero, signifying no edges present, there are also no cases in which the degree of slope between edges is very drastically falling into the 255 range. While there is a wide distribution of edges across the image, this random noise image also contains no readily identifiable shapes. The edge histogram of FIG. 7 shows that there are many edges with degrees of slope in the mid range. This signifies that there are too many edges occurring too frequently. While edges are necessary to define a shape, it is often the space between groups of edges that give a shape definition.

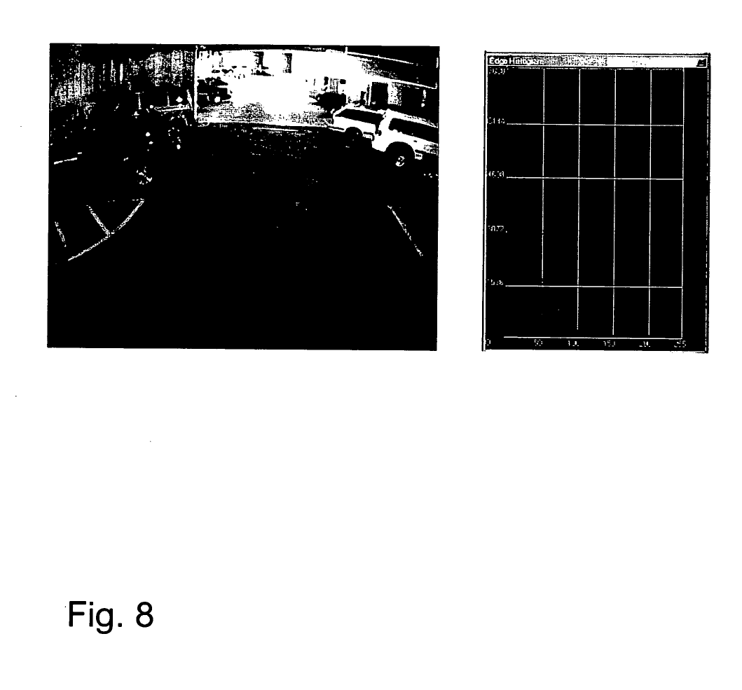

FIG. 8 shows video of a typical scene from a parking garage. The corresponding edge histogram of the figure gives very important information as to the quality of the video image. In this image, the empty traffic lane comprises the largest part of the viewing area. Since the lane is of a fairly uniform gray there will not be a significant degree of slope for much of the image area. The edge histogram reflects that, showing most of the values to be in the lower ranges of the histogram. The largest degrees of slope in this image occur on objects other than the traffic lane, such as the vehicles. These larger degrees of slope are displayed in the mid-range of the edge histogram of the figure. The video image in this illustration is a good example of a clear and sharp image. Edges are very well-defined within the image, while areas that are flat are consistently flat with little visible noise. The edge histogram reflects this showing a good distribution of high degrees of slope, representing good crisp edges in the image, to low degrees of slope, representing more uniform areas in the image.

The edge histogram, much like the grayscale histogram, plays an important role in describing the sharpness of an image. An edge histogram that contains a greater proportion of low degrees of slope and lesser proportion of high degrees of slope informs that an image is in proper focus. An image with a corresponding edge histogram of this nature informs that the edges in the image are crisp and that flat areas have little visible noise in them.

As with the grayscale histogram, it is important to note that the edge histogram does not retain any spatial data for these edges. An edge histogram of this nature shows only the frequency of the varying degrees of slope for a given image, but does not show the location of those edges.

Horizontal/Vertical Sharpness. Horizontal versus vertical sharpness plot can be graphically represented, by using a graph that shows the overall sharpness of an image based on the ratio of the horizontal to vertical sharpness along any given line of the image. Alternative, the plot need not necessarily be visually presented but can instead be realized in a an array by means of digital processor. By evaluating the average horizontal sharpness on a line with the average vertical sharpness on the same line, one can tell if that line of an image is in proper focus. By use of this technique for looking across all of the lines in the image, use of this criterion presents a good general overview of all areas of that image and determines overall focal quality.

The X-axis of such a graph or plot represents the difference between the average horizontal and average vertical degrees of slope. Values range from −255 to 255. Although the present patent drawings do not carry color attributes, colors are useful.

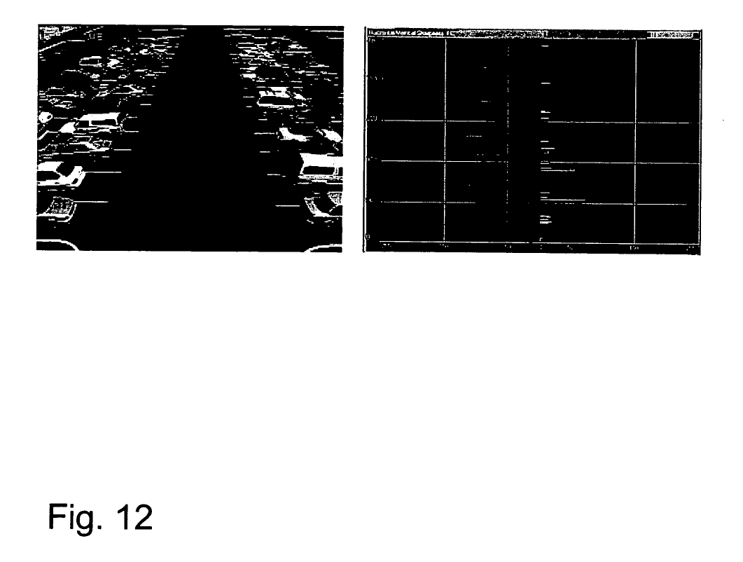

FIG. 12 is representative of a horizontal versus vertical sharpness graph, wherein values to the left of the vertically-oriented central meridian at value zero, may be in red and, moving towards the left side of the graph, represent a greater horizontal average. By comparison, values to the right of the central meridian, may be in green, being those moving towards the right side to represent a greater vertical average. Values at zero (on the meridian) indicate that the average horizontal and average vertical degrees of slope are in balance and that the image is very crisp.

The Y-axis of such a graph for the image in the above-identified figure represents the line within the image over which the average horizontal and average vertical degrees of slope have been calculated. Values range from zero at the bottom of the image to the height of the image at the top. Unlike the histograms discussed previously, this horizontal to vertical sharpness graph does contain spatial information. Values along the Y-axis correspond directly to a line within the image. A good indication as to the sharpness of an image in any given area is obtained accordingly.

The following figures and examples demonstrate more specifically the relationship between an image and its corresponding horizontal versus vertical sharpness.

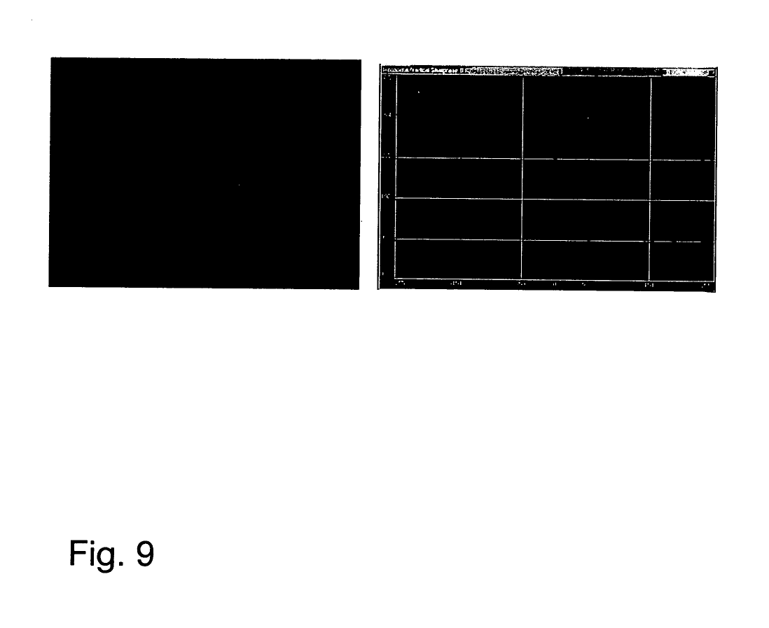

FIG. 9 shows a flat mid-tone gray image and the corresponding horizontal versus vertical sharpness graph. The graph shows that all of the horizontal and vertical degrees of slope cancel out perfectly. The reason this occurs is that absolutely no edges are within this image. This shows that within flat areas of an image the resultant area of the graph will always be zero.

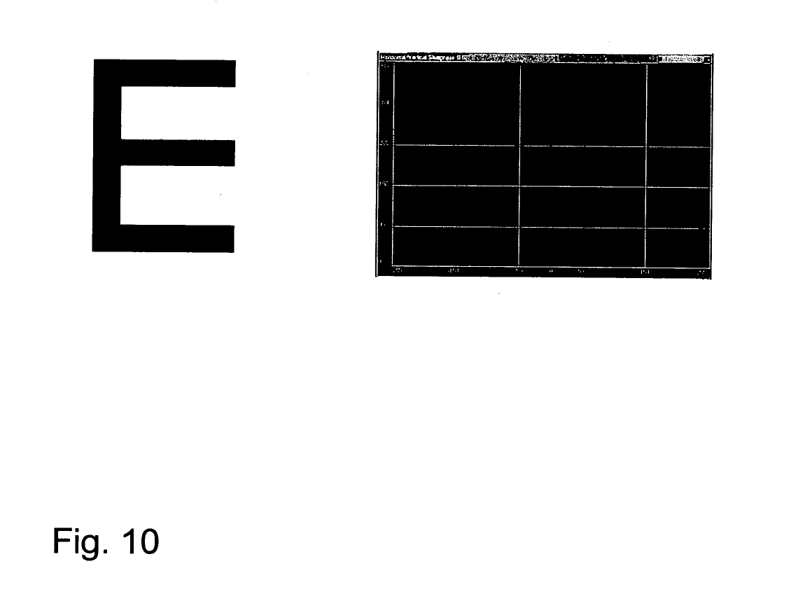

FIG. 10 shows an image containing a block letter E. There, all horizontal and vertical edges within this image are sharp and crisp. The corresponding horizontal versus vertical sharpness graph of the figure shows that for all areas of the graph the average of the horizontal degrees of slope and the average of the vertical degrees of slope cancel each other out, signifying that all of edges are in good focus.

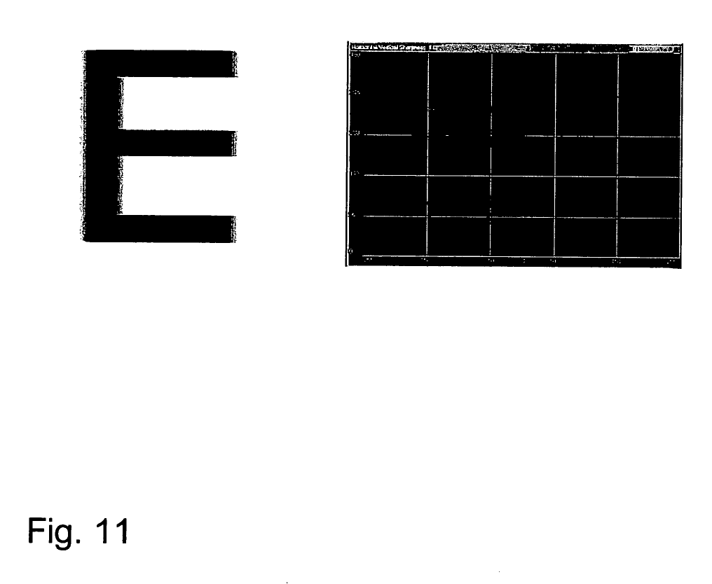

FIG. 11 shows the same block letter E as in FIG. 10 but after the effects of high frequency roll-off, which is discussed further below. In the associated horizontal versus vertical sharpness graph one sees in the three major portions of the image that horizontal edges within the image are very sharp while corresponding vertical edges a very blurry. All of the white areas are flat and have a resultant value of zero on the horizontal versus vertical sharpness graph.

FIG. 12 specifically shows a horizontal versus vertical sharpness graph for a video view of an outdoor parking facility. This graph shows that vertical edges are very sharp in comparison to horizontal edges. Although a first impression of the image seems at first impression to indicate a rather good, clear image, close examination of the horizontal versus vertical sharpness graph shows otherwise. The graph indicates that the video image is being adversely affected by high frequency roll-Off. While to the human eye the image may seem satisfactory, a software-driven video analysis or processing system, such as the Perceptrak system will only with difficulty identify (and be able to segment) people and cars within such an image experiencing high frequency roll-off.

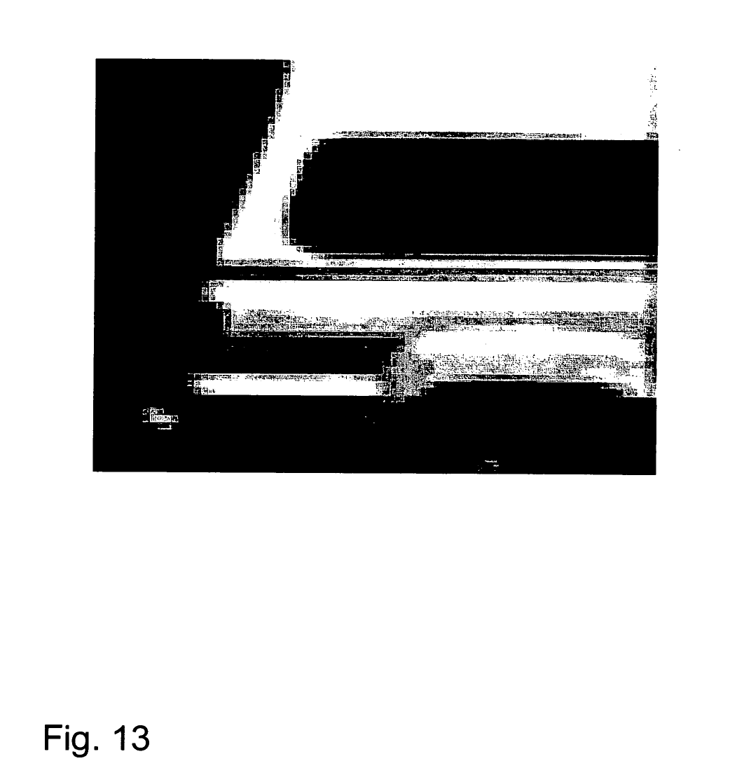

FIG. 13 depicts a zoomed-in image of one of the vehicles from the parking facility image of FIG. 12. Upon first impression one can see that the horizontal lines in this image appear sharp and well-defined, forming crisp edges. The vertical lines in this image, however, are blurred, the edges being not well-defined. In a video analysis system the effect of high frequency roll-off can substantially degrade accuracy of video analysis.

A horizontal versus vertical sharpness graph is a useful tool in determining the sharpness of an image in relation to the amount of bandwidth available in a video stream. A video stream constrained by limited bandwidth will show effects within the video signal itself. The effects are evident in an image along the vertical edges. These edges become blurry, bleeding outwardly with no clearly defined edge. Such is an effect of high frequency roll-off. A video signal so constrained by low bandwidth does not have the speed necessary to transition sharply from low to high or high to low and so create a well-defined edge. Instead, the transition from high to low will occur over time, creating a blurring of the edge. Since an image within a video signal is drawn line by line from top to bottom of a screen, horizontal edges are never adversely affected by high frequency roll-off.

Use of a horizontal versus vertical sharpness graph allows determining whether a video stream is suffering the effects of high frequency roll-off resulting from lack of available bandwidth. In using the color technique discussed above, such graphs with a large amount of green show very sharp vertical edges and signify that the video stream has plenty of bandwidth to properly display the image. Since horizontal edges are unaffected by high frequency roll-off an image with a large amount of red present in the horizontal versus vertical sharpness graph does not imply that the horizontal edges are very sharp and a low amount of red does not signify that the horizontal edges are blurry. Instead, a large amount of red signifies that the vertical edges are not as crisp as the horizontal edges in the same area.

Scoring. A “Check Video” score is a total score determined by use of the three techniques described above. It may be calculated without human intervention within a video analysis system, such as the Perceptrak system described above, or other image-handling or video processing or analysis system. This total score is calculated by first calculating individual scores for the grayscale histogram, the edge histogram, and the horizontal versus vertical sharpness graph. These scores are then combined, as by software-driven processing, to create the final total score. Each subpart score is determined by attaching weights to the calculated values. These weights are used to adjust the importance of the values as opposed to the overall score. These weights may be adjusted so that more or less importance is given to any piece of the gathered data. The total score provides an objective quantifying value that is indicative of the overall quality of a video image or, more broadly, a video signal or other comparable images and signals wherein quality is to be determined.

The grayscale score is found by computing the grayscale as if the intensity value were a so-called altitude. This altitude is then averaged, with penalties applied for unused values and differences in elevation of the altitudes. The following pseudo code describes the calculation of the grayscale score:

PenaltyForUnusedValues=UnusedValueWeight*(DarkValuesNotUsed +

rightValuesNotUsed)

GrayValuesUsed = AltEles − (BrightValuesNotUsed +

DarkValuesNotUsed)

```
TotalEles = (SizeX \ 2) * (SizeY \ 2)
FlatDistEles = TotalEles \ AltEles
For Counter = LngZero To AltEles − 1
    TotalDiffFromFlat = TotalDiffFromFlat +
    Abs(AltHisto(Counter) − FlatDistEles)
Next Counter
AverageDiffFromFlat = TotalDiffFromFlat \ AltEles
DiffFromFlatPenalty = AverageDiffFromFlat * DiffFromFlatWeight
DiffFromNormalizedPenalty = DiffFromNormalWeight * Abs(AvgAlt −
```

NormalAlt)

AltThresholdScore = StartingScore − DiffFromFlatPenalty −
PenaltyForUnusedValues − DiffFromNormalizedPenalty

The edge score is calculated by summing up all of the edges found and creating an average slope for the image. This slope is combined with the good edges found, the average slope of the edges and the total number of edges to create an overall score for this frame.

The following pseudo code demonstrates how the edge score is calculated:

```
For Counter = MinEdgeThreshold To EdgeEles − 1
          TotalEdgesFound = TotalEdgesFound +
          edgeHisto(Counter)
    TotalEdgeValue = TotalEdgeValue + (Counter *
    EdgeHisto(Counter))
    If (Counter > GoodEdgeThreshold) Then
    GoodEdgesFound = GoodEdgesFound + EdgeHisto(Counter)
End If
Next Counter
AverageSlope = TotalEdgevalue \ TotalEdgesFound
EdgeThresholdScore = ((GoodEdgesFound − GoodEdgesBias) *
GoodEdgesWeight) + ((AverageSlope − AverageSlopeBias) *
AverageSlopeWeight) + ((TotalEdgesFound − TotalEdgesFoundBias) *
TotalEdgesFoundWeight)
```

The horizontal versus vertical sharpness score is determined by summing up the weighted differences between the horizontal and vertical edges and then determining an overall weighted score. The following pseudo code demonstrates how the Horizontal versus Vertical Sharpness score is calculated:

For Counter = LngZero To DiffEles − 1
RawDiffs = RawDiffs + HorVerEdgeDiff(Counter)
Next Counter
DiffScore = RawDiffs * DiffWeight
HtoVscore = DiffScore
HiFreqRolloffDeduct = HtoVscore \ HtoVdeductWeight

All of the above scores are used to calculate the overall total score. This score will provides the overall quantifier for determining a good video signal or image. The total score is determined by summing up the weighted values of the grayscale score and the edge score. Then the deduction for the high frequency roll off is applied. The following pseudo code demonstrates how the Check Video Score (total score) is calculated:

CheckVideoScore = ((EdgeThresholdScore * EdgeThresholdWeight) +
(AltThresholdScore * AltThresholdWeight)) \ (EdgeThresholdWeight +
AltThresholdWeight)
CheckVideoScore = CheckVideoScore + HiFreqRolloffDeduct

As is seen from the last line of code, compensation is made to the total score function CheckVideoScore according to the need, if any, for compensating for high frequency roll-off experienced in the system.

The total score can be frequently calculated and provided, and such scoring may be done in real time as video data is captured by a video camera, with scores provided in brief intervals such as less than a second. Each total score as provided is an objective measure that correlates directly with the frame of a video stream provided by a video camera, for example. This score can then be used to verify the quality of that frame. A high score will give the viewer, user, or other device or system, objective numerical assurance that the video signal or other image or image frame is of a high quality.

Each of the criteria has unique advantages. Different purposes are served by each of the grayscale histogram, the edge histogram, and the horizontal versus vertical sharpness graph. Usable quality analysis can be learned by using only one, or only two, of the grayscale histogram, the edge histogram, and the horizontal versus vertical sharpness graph criteria.

For example, horizontal versus vertical sharpness plotting or graphing (however carried out by processor and written to an array, e.g., for a whole frame or for a portion of an area of a frame, apart from the other criteria, would give a good indication of loss of bandwidth due to a too long coax. Using the edge histogram analysis only would give a good indication of camera focus and condition of dust on the lens. Using the grayscale histogram only would give a good indication of the level of contrast in the scene.

Any one or any combination of these criteria may be regarded as useful but the application of all three together is most preferred as most advantageous, and provides a synergistic quality analysis and indication.

Resolutions greater than 8-bit grayscale data will look better to the human viewer, but in employing the grayscale histogram will take more processing time, and yet will produce the same scores.

In general, in carrying out methodology of the invention using the above-identified criteria, processor speed is not a limiting problem. As a practical matter, the frame rate can be selected to be quite rapid, such as several frames per second. As an example, a frame rate of 7 seven frames per second can be analyzed by the combined criteria here described by the use of a single typical 2.2 GHz processor. It is found that laptop and desktop computers are adequate for this purpose, and so also may be used “palm devices” or “hand-held devices” such as interactive devices of portable character, as of a type that may be carried in the palm by a user, or between fingers of the user. Because the methodology here described may be implemented by a single processor, it may be used in a variety of other portable devices, such as video cameras and digital cameras providing sufficient processing capability for implementing the criteria discussed, and providing suitable display or other indication (such as graphical or audible displays) or other use of the total quality score.

The present invention is not limited to the analysis of video images, nor to continuous video. So also, quality analysis by the present inventive methodology can be executed for various kinds of image-producing signal frames, or electronically formed images, apart from video. That is, a digitally or analog-formed image frame, whether as a single frame, or a sequence of frames, can be analyzed by the inventive system for quality. Single frames can be analyzed, e.g., as presented by bit map files of .BMP format, which is to say a standard bit-mapped graphics format used in the Windows(™)-brand software environment in a format referred to as device-independent bitmap (DIB).

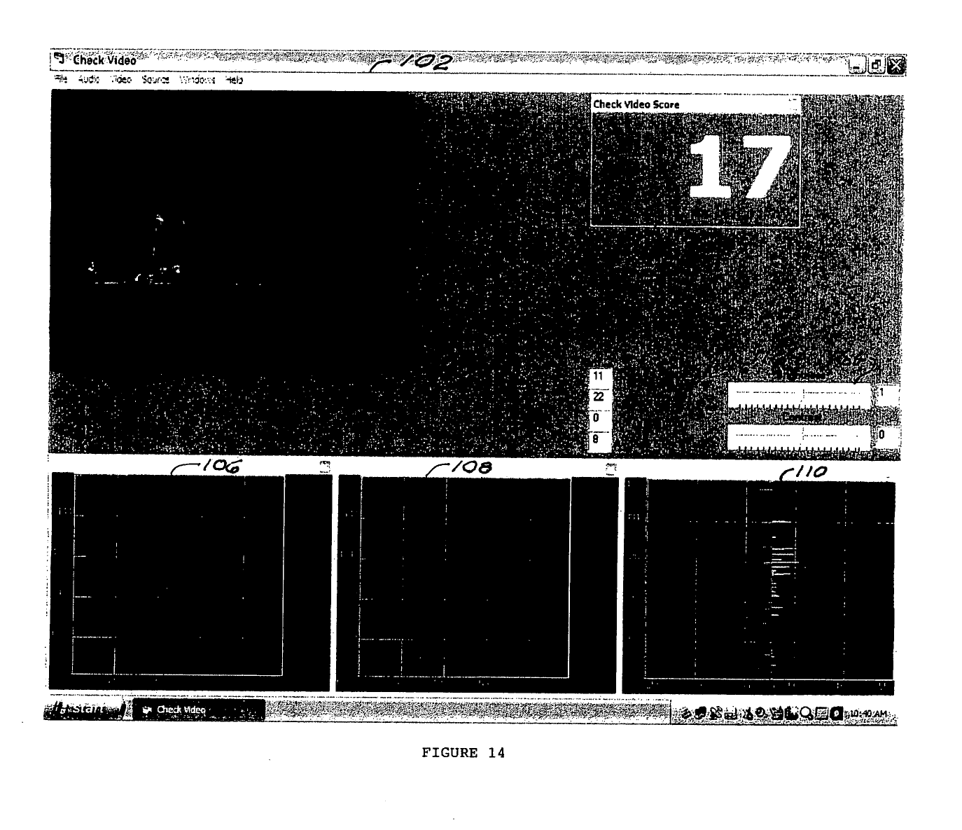

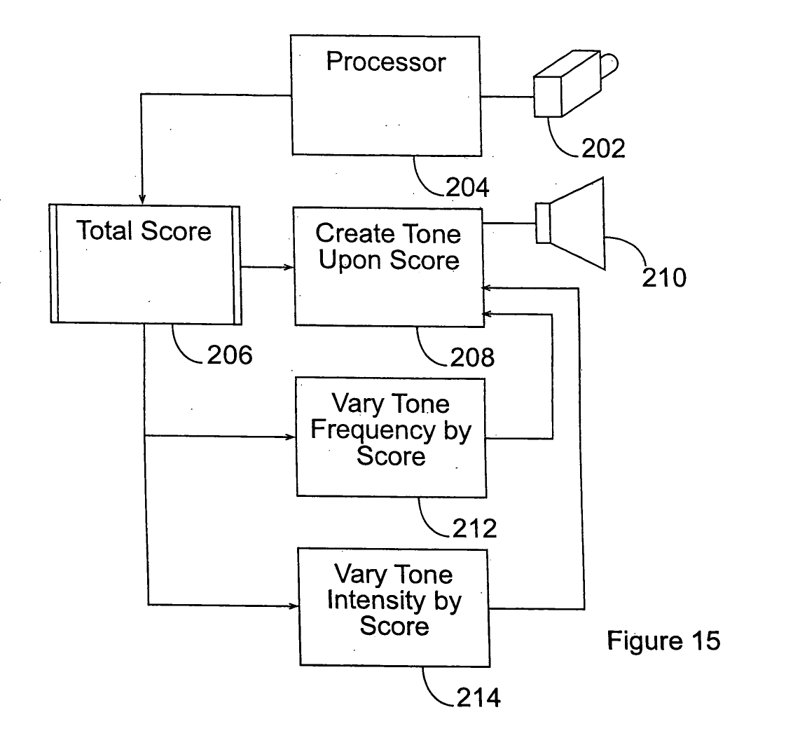

Referring to FIG. 14, which shows a first exemplary method of presenting the total score, a system or computer monitor screen display 102 shows graphic depiction of applied criteria of the present methodology, together with a monitor-reproduced portion in a window 104 of a video-captured scene, graphic displays of the applied criteria the grayscale and edge histograms and horizontal versus vertical sharpness graph in respective windows 106, 108, and 110, and displays of the scoring for each of the criteria in another window 112, and total score display for the scene, in a window 114, based on use and scoring of the criteria. Screen display 102 may be that of a laptop or desktop or system computer or processor, such as that designated 204 in FIG. 15, discussed below. The image frame in window 104 is for illustration chosen to be one giving an impression of poor quality in having dark, poorly distinguished images, and high contrast. The grayscale histogram shows, as expected, proportionately high incidence of dark pixels, and scores low accordingly. The edge histogram similarly shows an abnormal frequency distribution of edges found within the given image, with low edge scoring, while the horizontal versus vertical sharpness graph displayed in window 110 also scores low from its determination of low sharpness of the image in relation to the amount of bandwidth available in the video. The total score in window 114 shows accordingly a low value of 17 for the displayed image frame.

In such a display window 102, it is found useful to provide screen selection bars for image brightness and contrast control, as shown at 116a and 116b.

As the inventive methodology and system relates generally to displays for a user, it is to be understood that use of the histogram and graphical displays, and presentation of the scoring from them, conveniently and usefully may be employed by display for the benefit of an operator or user, or may be employed additionally or alternatively for internal machine-implemented or archiving purposes, and for many other analytical and other purposes. The criteria scoring and display, and the total score and its uses or display are not limited in use. Use of the present methodology does not require display per se, but can produce criteria scoring and total scoring for such internal purposes, as well as in applications for providing scoring indications other than numerical. The next figure so demonstrates such an application.

Referring to FIG. 15, a block diagram illustrates an exemplary one of possible methods of using a total score created by the present methodology for providing indications other than numerical. A video camera 202 is provided to a system processor 204, such as processing components like those used in the Perceptrak system. Processor 204 may be a processor-controlled video selection, analysis and control system. The video stream is analyzed by the processor for quality in accordance with the above-described techniques. Accordingly processor 204 or its equivalent within such a system must be one capable of executing (1) the grayscale histogram, (2) the edge histogram, and (3) the horizontal versus vertical sharpness graph, by processor-implemented analysis of successive frames of data, at a suitably rapid rate, such as preferably in real time, to provide a total score as frequently as, or much more frequently than, once per second. Block 206 indicates the provision of such total score on such a periodic basis by processor 204. Block 208 indicates a tone producing circuit module or component of conventional circuit design or processor function capable of generating an audible tone, within the normal human range of comfortably audible frequencies. A transducer 210, such as a speaker or earphone, or in lieu thereof, a visual or graphic indicator, provides perceptible signalling in response to the provision of each total score. At block 212, a tone control module or circuit of known type or processor function converts the total score (as by digital-to-analog (D/A) conversion, or by processor output, to a tone control output which is a function, such as direct proportionality, of the magnitude of the total score, for causing tone module or function 208 to provide its output to transducer 210 at a tone frequency which corresponds to the total score. Block 214 depicts an intensity or loudness control module or circuit of known type or processor function to convert the total score, as by D/A conversion, or by processor output, to an output which is a function, such as direct proportionality, of the magnitude of the total score, for causing tone module 212 to provide its output to transducer 210 at an output level (such as audible loudness) which corresponds to the total score. Transducer 210 accordingly provides a series of repeating signal outputs, such as audible beeps, which vary in tone and intensity according to the total score. Instead of circuit components or modules, the foregoing functions all may be realized by the processor (CPU) of a laptop and desktop computer or system capable of executing and causing display of the criteria. Some blocks of this figure may represent devices, circuits, modules or processor functions. In any event, means or provision is operable upon processor 204 giving or providing a total score for each image quality analysis to produce an audible tone, wherein the production of successive tones corresponds to each successive quality analysis by the processor. Further provision is made for varying the frequency of the audible tone as a function of the value of the total score, and further provision is made also for varying the intensity of the audible tone as a function of the value of the total score, whereby a user is given audible indication by the audible tone of the value of the audible tone. Here, the term audible tone is used in a broad sense, and may include various sounds, polytones and various audible indications serving to convey useful indication to the user of the value of the total score.

As an example of one kind of use of the foregoing system configuration, a video camera as here described may be aimed at a video scene or subject. As the camera focus is adjusted, or as light levels or video-capture conditions vary, the output of transducer 210 varies as a function of the quality of the video. As the camera comes, for example, into sharp focus of good video subject matter, the tone and loudness of successive beeps will rise.

As another example of use, the video-checking methodology of the invention may be run in a video-handling or video-processing system. It may be used initially for video camera(s) setup, as when camera focus and output quality are to be initially determined. It may also be used periodically and regularly in systems (such as security systems) that have multiple video cameras, to provide a periodic report of the performance of the cameras and their components and to anticipate a projected failure or anticipated degradation thereof.

Various other devices and means can be used to translate the total score into usable indicia or signals of value to a human user or to machine-implemented devices for which the video quality is to be determined. For example, a meter or indicator within a video camera viewfinder may be driven to provide analog or digital or quantitative visual indication of quality of the video in accordance with the total score thus calculated.

As various modifications could be made in the systems and methods herein described and illustrated without departing from the scope of the invention, it is intended that all matter contained in the foregoing description or shown in the accompanying drawings shall be interpreted as illustrative rather than limiting.

Thus, the breadth and scope of the present invention should not be limited by any of the above-described exemplary embodiments, but should be defined only in accordance with the following claims appended hereto and their equivalents.

1. A system for determining the quality of video or other electronically reproduced or generated images by quality analysis, comprising:
means for providing one or more frames of image data for analysis;
at least one digital processor;
programming for the processor;
the programming causing the processor to implement analysis of the frames according to one or more of a set of multiple criteria and to provide respective criteria outputs for the criteria;
the criteria outputs being combinable by the processor to produce a total score representing the quality of the frames as they are analyzed.

2. A system as set forth in claim 1 wherein the criteria are a grayscale histogram, an edge histogram, and a horizontal versus vertical sharpness graph, and the criteria outputs are a grayscale score, an edge score, and a horizontal versus vertical sharpness score.

3. A system as set forth in claim 2 wherein the processor is operable to sequentially analyze frames of a sequence of frames, to produce for each frame of the sequence the grayscale histogram, the edge histogram, and the horizontal versus vertical sharpness graph.

4. A system as set forth in claim 2 wherein the grayscale histogram represents the frequency distribution of intensity values within an image, and wherein an even distribution across the grayscale histogram is indicative of an image having good contrast so as to provide a relatively detailed image.

5. A system as set forth in claim 2 wherein the edge histogram represents a frequency distribution of edges found within a given image, and is descriptive of relative sharpness of such an image, the edge histogram when containing a greater proportion of low degrees of slope and lesser proportion of high degrees of slope informing that such an image is in proper focus, and being relatively thereby indicative of the degree to which edges in such image are crisp and that flat areas have little visible noise in them.

6. A system as set forth in claim 2 wherein the horizontal versus vertical sharpness graph represents overall sharpness of an image based on the ratio of the horizontal to vertical sharpness along any given line of the image, and wherein average horizontal sharpness on a line with the average vertical sharpness on the same line is indicative of an image is in proper focus, and wherein examination of lines over the image over areas thereof is indicative of overall focal quality.

7. A system as set forth in claim 2 further including a display for showing for an image-containing frame to be analyzed at least
(a) the grayscale histogram for the frame,
(b) the edge histogram for the frame,
(c) the horizontal versus vertical sharpness graph for the frame,
(d) a grayscale score for the grayscale histogram,
(e) an edge score for
(f) a horizontal versus vertical sharpness score for the sharpness graph, and
(g) the total score.

8. A system as set forth in claim 7 wherein the display also shows the image-containing frame to be analyzed.

9. A system as set forth in claim 2 including provision operable upon the processor providing a total score to produce an audible tone, further provision for varying the frequency of the audible tone as a function of the value of the total score, and further provision for varying the intensity of the audible tone as a function of the value of the total score, whereby a user is given audible indication by the audible tone of the value of the audible tone.

10. A system as set forth in claim 2 further including provision operable upon the processor providing a total score to produce an audible tone, wherein the tone varies as a function of the value of the total score, whereby a user is given audible indication by the audible tone of the value of the audible tone.

11. A system as set forth in claim 2 further including provision operable upon the processor providing a total score to produce an audible tone, further provision for varying the frequency of the audible tone as a function of the value of the total score, and further provision for varying the intensity of the audible tone as a function of the value of the total score, whereby a user is given audible indication by the audible tone of the value of the audible tone.

12. A system for determining the quality of image frames of video or other electronically reproduced or generated image data by quality analysis, comprising:
means for providing one or more frames of image data for analysis;
at least one digital processor;
programming for the processor;
the programming causing the processor to implement:
(a) analysis of the image frames according to one or more of a set of multiple image analysis criteria, the image analysis criteria being a grayscale histogram, an edge histogram, and a horizontal versus vertical sharpness graph,
(b) provision respectively therefrom of output scores according to the analysis criteria, namely a grayscale score, an edge score, and a horizontal versus vertical sharpness score,
(c) weighted combination of respective criteria output scoring according to the analysis criteria as a total score representing the quality of the frames as they are analyzed.

13. A method for objectively quantifying criteria to determine the quality of a video- or image-defining signal, comprising
providing one or more of a series of electronically reproduced or generated image frames for digital analysis,
operating programmed digital processing means for analysis of the one or more image frames according to at least one of a set of multiple criteria to provide respective criteria outputs for the criteria;
causing the processing means to combine the criteria outputs so as to produce a total score representing the quality of the image frames as they are analyzed.

14. A method according to claim 13 wherein the criteria are a grayscale histogram, an edge histogram, and a horizontal versus vertical sharpness graph, and wherein the method further comprises:
as each image frame is provided, causing the processing means to analyze each provided image frame is provided to produce the grayscale histogram, the edge histogram, and the horizontal versus vertical sharpness graph for the frame, and
operating the processing means to combine scores respectively associated with each of the histograms and the sharpness graph to produce a total quality score objectively indicative of the quality of the provided image frame.

15. A method according to claim 13 wherein the image frames are of a sequence of video images.

16. A method according to claim 13 wherein the image frames are of a sequence of video images provided in real time, and the method comprises operating the processing means to provide the total quality score on a real-time basis corresponding to the provision of the image frames.

17. A method according to claim 13 further comprising providing a visible indication for a user varying according to the value of the total score.

18. A method according to claim 13 further comprising providing an audible sound having a characteristic varying according to the value of the total score, whereby a user is given audible indication by the audible sound of the value of the audible tone.

19. A method according to claim 18 wherein the audible sound is a tone for which the frequency or the intensity of the tone is varied as a function of the value of the total score.

20. A method according to claim 18 wherein the audible sound is presented upon each production of the total score, corresponding to the completion of quality analysis of an image frame.
